(19) United States
(12) Patent Application Publication
(10) Pub. No.: US 2008/0243531 A1
(43) Pub. Date: Oct. 2, 2008

(54) System and method for predictive targeting in online advertising using life stage profiling

(75) Inventors: Adam Hyder, Los Altos, CA (US); Chyr-Chong Joseph Ting, San Jose, CA (US)

Correspondence Address: Law Office of Robert O. Bolan, P.O. Box 36, Bellevue, WA, 98009, US

(73) Assignee: Yahoo! Inc., Sunnyvale, CA (US)

(21) Appl. No.: 11/731,369

(22) Filed: Mar. 29, 2007

(51) Int. Cl. G06Q 30/00

(52) U.S. Cl. 705/1

(57) ABSTRACT

An improved system and method for predictive targeting in online advertising using life stage profiling is provided. A life stage profiling engine may be provided in an embodiment for generating a life stage profile for a user. A life stage profile may include a collection of events or a distribution of characteristics that may represent a life stage of a taxonomy of life stages that may be generated from online or offline events. The events and attributes may be categorized and assigned a probability that a user may belong to a particular life stage, and the life stage of a user may be determined using the assigned probabilities, for instance, by applying naïve Bayesian techniques. Predictive targeting may be applied, either online or offline, using life stage profiles to target users for receiving advertising, content, ecommerce offers or other electronic communications.

### FIELD OF THE INVENTION

The invention relates generally to computer systems, and more particularly to an improved system and method for predictive targeting in online advertising using life stage profiling.

### BACKGROUND OF THE INVENTION

Operators of websites offering online content may manage an inventory of advertisements that may be shown to visitors viewing content of a website. When a user may visit a website, the operator of the website or a third party may choose to show one or more advertisements to the user with the expectation that the user may select an advertisement to buy advertised goods or services. Advertisers may bid to have their advertisement shown to a visitor viewing particular content of the website. Or the operator of the website or third party may choose the advertisement and may generate revenue whenever a visitor may select an advertisement shown while viewing content of the website.

As online content and advertisement inventory grows, there needs to be better optimization in bringing the right content and services to the right user. Current implementations in behavior analysis and targeting consider only limited attributes of individuals collected from behavior patterns for online advertising and content match applications. For instance, existing systems today involve collection of personal information limited to current descriptive characteristics of an individual, such as age, sex, education level, race, and so forth, or recent behavior patterns such an online surfing, or transactional events such as ecommerce purchases. Moreover, different business verticals process and apply the profile information of an individual without an understanding of the context of the profile information in the evolution of an individual's life. For example, in the employment vertical, the employment history and past professional contacts of an individual may be used to determine the qualifications and the type of employment in which an individual be interested while ignoring changes in the professional and social network of the individual. Unfortunately, such systems fail to recognize that profiles of individuals evolve. As a result, applications apply predictive targeting based on clusters of attributes without including a broader understanding of the evolution of an individual's life.

What is needed is a way to more comprehensively understand the context of behavior patterns, descriptive characteristics, and ecommerce transactions of an individual so that applications such as online advertising may more accurately apply predictive targeting based on an understanding of an individual's life rather than clusters of data about the individual. Such a system and method should also be able to understand the context of behavior patterns and descriptive characteristics as an individual's profile evolves.

### SUMMARY OF THE INVENTION

Briefly, the present invention may provide a system and method for predictive targeting in online advertising using life stage profiling. A life stage profiling engine may be provided in an embodiment for generating a life stage profile for a user. A life stage profile may include a collection of events or a distribution of characteristics that may represent a life stage of a taxonomy of life stages that may be generated from online or offline events. For instance, a taxonomy of life stages may include grade school, high school, college, married life, homeowner, family, retired, and so forth. The life stage profiling engine may include an operably coupled event classifier for categorizing online and/or offline events and for assigning probabilities given the event that the user may belong to a particular life stage. The life stage profiling engine may apply naïve Bayesian techniques using the assigned probabilities of the events in an embodiment to determine a life stage of a user in order to generate a life stage profile of the user.

In an embodiment, user events and attributes may be received from a variety of sources such as a user profile, neighborhood demographics of an individual, transaction history, social network history, family background, and so forth. Such events and attributes may then be categorized and assigned a probability that a user may belong to a particular life stage. The life stage of a user may be determined using the assigned probabilities, for instance, by applying naïve Bayesian techniques using the assigned probabilities in an embodiment to determine a life stage of a user. And a life stage profile for a user may be generated and stored for use by predictive targeting applications.

The present invention may support many online applications using predictive targeting. For example, online search applications may use the life stage profile of users to select advertisements for display to the users. Online content match applications may use the life stage profile of users to select content for display to a user. Or an ecommerce application may use the life stage profile of users to present an offer for purchase of goods or services. Moreover, predictive targeting may also be applied, either online or offline, using one or more life stage profiles to determine the interests of an individual user or a group of users for receiving an non-electronic communications such as by postal mail service. Thus, the present invention may more accurately perform predictive targeting in a variety of online and offline applications by expanding the tracking history of behavior patterns, transactional events, and descriptive characteristics of an individual to include lifetime events and attributes of an individual. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for predictive targeting in online advertising using life stage profiling, in accordance with an aspect of the present invention;

FIG. 3 is a flowchart generally representing the steps undertaken in one embodiment for predictive targeting in online advertising using life stage profiling, in accordance with an aspect of the present invention; and

FIG. 4 is a flowchart generally representing the steps undertaken in one embodiment for generating a life stage profile, in accordance with an aspect of the present invention.

### DETAILED DESCRIPTION

### Exemplary Operating Environment

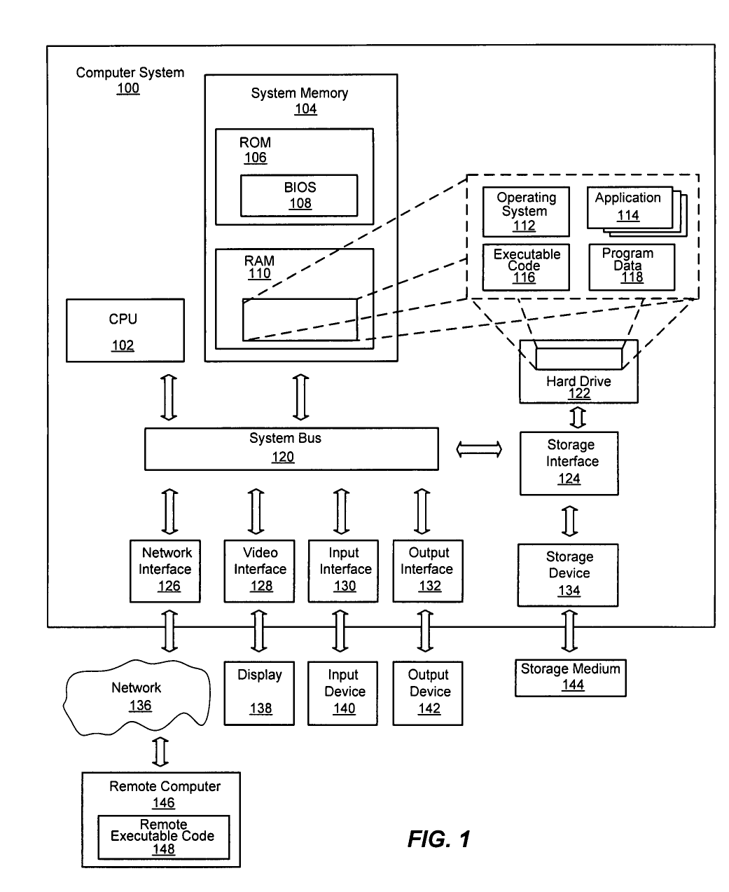

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

### Predictive Targeting In Online Advertisign Using Life Stage Profiling

The present invention is generally directed towards a system and method for predictive targeting in online advertising using life stage profiling. As used herein, a life stage profile may mean a collection of one or more events or a distribution of characteristics that may represent a life stage of an individual. A life stage may mean one or more defined states in the development of an individual's life. For instance, a taxonomy of life stages may include grade school, high school, college, married, homeowner, family, retired, and so forth. The present invention may provide a life stage profiling engine that may apply classification techniques to online and/or offline user events to generate a life stage profile. A life stage profile may subsequently be used by predictive targeting applications for online advertising.

As will be seen, applications that may display advertisements to users who visit a web site, including managed content properties, may also use the present invention to select advertisements using life stage profiles for display to individuals. As will be understood, the various block diagrams, flow charts and scenarios described herein are only examples, and there are many other scenarios to which the present invention will apply.

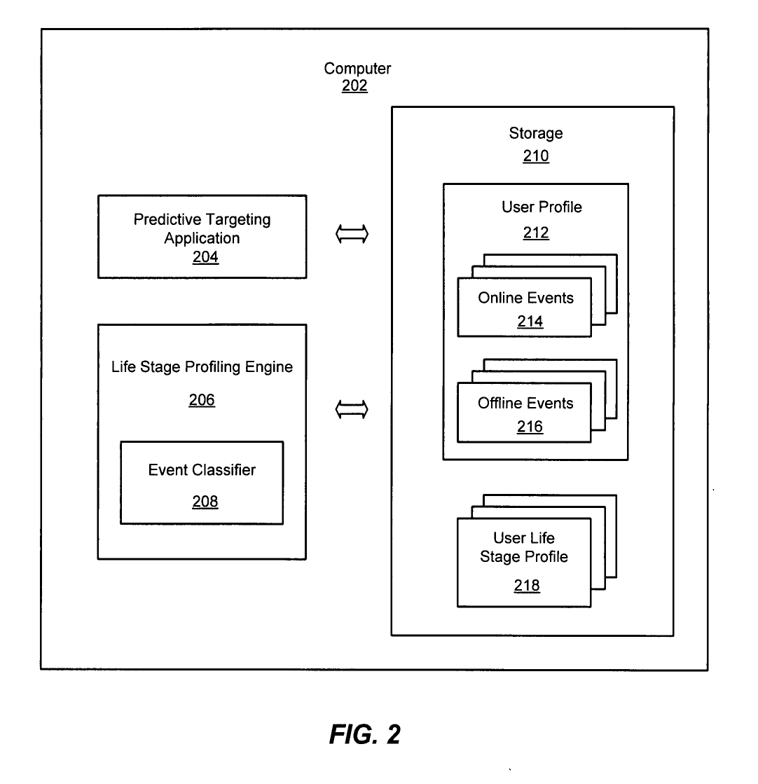

Turning to FIG. 2 of the drawings, there is shown a block diagram generally representing an exemplary architecture of system components for predictive targeting in online advertising using life stage profiling. Those skilled in the art will appreciate that the functionality implemented within the blocks illustrated in the diagram may be implemented as separate components or the functionality of several or all of the blocks may be implemented within a single component. For example, the functionality for the event classifier 208 may be implemented as a separate component from the life stage profiling engine 206. Or the functionality of the predictive targeting application 204 may be implemented on another computer as a separate component from the computer 202. Moreover, those skilled in the art will appreciate that the functionality implemented within the blocks illustrated in the diagram may be executed on a single computer or distributed across a plurality of computers for execution.

In various embodiments, a computer 202, such as computer system 100 of FIG. 1, may include a predictive targeting application 204 and a life stage profiling engine 206 operably coupled to storage 210. In general, the predictive targeting application 204 and the life stage profiling engine 206 may be any type of executable software code such as a kernel component, an application program, a linked library, an object with methods, and so forth. The storage 210 may be any type of computer-readable media and may store user profiles 212 and user life stage profiles 218 generated by the life stage profiling engine 206. The user profiles 212 may include online events 214 representing user properties from online activities and offline events 216 representing user properties collected offline. A user life stage profile may represent events defining a life stage of a taxonomy of life stages that may be generated from online or offline events. For instance, a taxonomy of life stages may include grade school, high school, college, married life, homeowner, family, retired, and so forth. Various online and/or offline events may generate an event defining a life stage in a taxonomy. For example, an offline event capturing real estate tax paid by an individual may generate an event defining a life stage of homeowner.

The life stage profiling engine 206 may apply classification techniques, such as naïve Bayesian techniques, for generating a life stage profile. To do so, a life stage profiling engine may include an event classifier 208 for categorizing online and/or offline events for generating a life stage profile. In various embodiments, an event classifier may categorize and assign probabilities for events. The life stage profiling engine 206 may then apply naïve Bayesian techniques using the assigned probabilities of the events in an embodiment to determine a life stage of an individual. The event classifier 208 may also be any type of executable software code such as a kernel component, an application program, a linked library, an object with methods, or other type of executable software code.

There are many predictive targeting applications which may use the present invention. For example, online search applications may use the life stage profile of individuals to select advertisements for display to the individuals, such as advertisements to refinance a mortgage that may be displayed for individuals in the life stage of a homeowner. Similarly, online content match applications may use the present invention to select content for display to an individual using the life stage profile of the individual. Articles for senior citizens may, for instance, be displayed for individuals in a retired life stage. Or an ecommerce application may use the present invention to predict a future electronic transaction based upon a past or present electronic transaction. As an example, an offer for a discount coupon to a particular hardware store may be sent to an individual upon completion of an electronic reservation for a moving van. Or an offer to purchase a pizza for delivery on the date of the reservation for the moving van may be sent to the individual completing the electronic reservation for the moving van.

In general, predictive targeting applications may consider a variety of behavior patterns and descriptive characteristics in predicting the interests of an individual, including a user profile, neighborhood demographics of an individual, the life stage of an individual, transaction history, social network, family background, and so forth. Characteristics from the user profile, such as age, and other events may be used to generate a life stage profile. Such events may be gathered, for instance, from records about schooling, health records, professional records, public records such as marriage licenses, housing permits, etc. The demographics of an individual's neighborhood may be stored in a neighborhood profile for the individual that may include information such as median property value, crime records, school test scores, average housing lot size, average income, population, and other demographics. Additionally, the history of neighborhoods where an individual lived may also be included as part of an individual's neighborhood profile.

A taxonomy of life stages may include various stages of habitat. For example, an individual may initially live in his/her parents home, then in a dormitory during college years, in an apartment upon graduation, in a first home, later in a second home, and finally in a retirement home, etc. A taxonomy of life stages may also include various stages of a career, changes of an individual's family, changes of an individual's social network, and so forth. During the lifetime of an individual, social behaviors may change and one indication of this is the type of friends an individual may have. It is important to keep track of an individual's social network as it may change during various stages in life, since the individual's social environment may be used to determine the interests, spending tendencies, favorite gathering spots, and other predicted behavior of the individual.

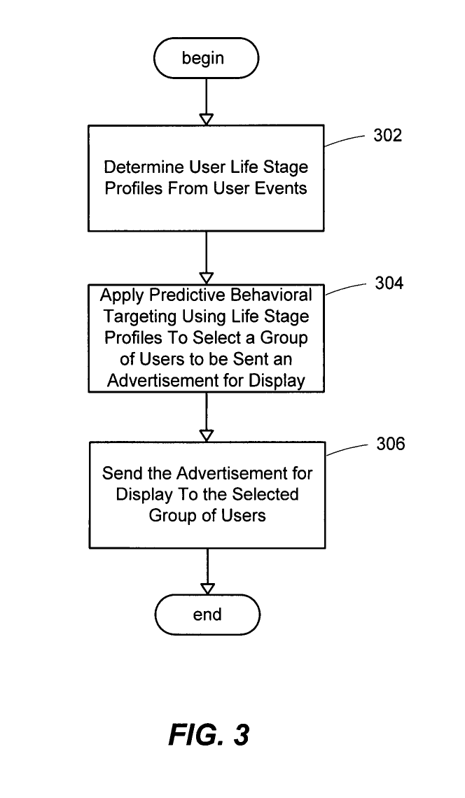

FIG. 3 presents a flowchart generally representing the steps undertaken in one embodiment for predictive targeting in online advertising using life stage profiling. At step 302, one or more user life stage profiles may be determined from user events and/or attributes. In an embodiment, user life stage profiles may be determined dynamically or periodically based upon changed online events and/or offline events. Attributes or characteristics from a user profile, such as age or marital status, and other events, such as online behavior patterns including search queries, may be used to generate a life stage profile. The culture of an individual may be included as a factor in determining a user's life stage profile, since different countries may exhibit different behaviors in different life stages. At step 304, predictive behavioral targeting may be applied using one or more life stage profiles to determine the interests of an individual user or a group of users for receiving an advertisement, online content, or other electronic communication. For an online search application, the life stage profile of an individual or groups of individuals may be used to select advertisements for display to the individuals or the targeted group of individuals. For an online content match application, the life stage profile of an individual or groups of individuals may be used to select content for display to the individuals or the targeted group of individuals. For an ecommerce application, the life stage profile of an individual or groups of individuals may be used to select an offer to send to the individuals the targeted group of individuals for completing an ecommerce transaction, such as a purchase. Moreover, predictive behavioral targeting may also be applied, either online or offline, using one or more life stage profiles to determine the interests of an individual user or a group of users for receiving an non-electronic communications such as by postal mail service.

At step 306, an advertisement, online content, or other electronic communication may be sent for display to the targeted user or group of users. Those skilled in the art will appreciate that predictive targeting applications may consider a variety of behavior patterns and descriptive characteristics in addition to the life stage of an individual for predicting the interests of an individual, including a user profile, neighborhood demographics of an individual, transaction history, social network, family background, and so forth.

A life stage profiling engine may provide services for generating life stage profiles from attributes and events gathered for an individual. Each event may represent an online or offline action of the individual. Online actions may include online behavior captured such as online purchases, surfing behavior, and other online behavior. Offline actions may represent offline behavior recorded in databases including purchase transactions, taxes paid, real estate taxes paid, and so forth. These events may come from private or public databases and may be stored in a user profile for an individual.

Each event may be categorized using an event database and may be assigned an event identification. A probability may also be assigned to an event that may indicate the likelihood that an individual may belong in a particular life stage of a taxonomy. In a taxonomy of youth, college, married, and homebuyer for example, life stage 1 (L1) may be defined as a youth from age 6 to 17; life stage 2 (L2) may be defined as an individual in college; life stage 3 (L3) may be defined as a married individual; and life stage 4 (L4) may be defined as a homebuyer. In an embodiment, an event indicating a first time online access at age 10 for an individual may be assigned an event ID such as #50 and an associated probability of p(L1, E50)=0.93 that may indicate there is a 93% probability that event #50 belongs to life stage 1. An event indicating a credit card purchase for the first time online at age 16 for an individual may be assigned an event ID such as #2208 and an associated probability of p(L2, E2208)=0.97 that may indicate there is a 97% probability that event #2208 belongs to life stage 2. An event indicating submission of an online college application at age 17 for an individual may be assigned an event ID such as #422 and an associated probability of p(L2, E442)=0.89 that may indicate there is a 89% probability that event #422 belongs to life stage 2. An event indicating submission of an online job application at age 26 for an individual may be assigned an event ID such as #343 and an associated probability of p(L3, E343)=0.78 that may indicate there is a 78% probability that event #343 belongs to life stage 3. An event indicating submission of an application for a first time home loan at age 28 for an individual may be assigned an event ID such as #7889 and an associated probability of p(L3, E7889)=0.88 that may indicate there is a 88% probability that event #7889 belongs to life stage 3. Or an event indicating a wedding related purchase at age 35 for an individual may be assigned an event ID such as #99900 and an associated probability of p(L4, E999000)=0.87 that may indicate there is a 87% probability that event #99900 belongs to life stage 4. Such events may be categorized into various life stages based on the highest probability of occurrence in a particular life stage for a group of users.

Life stage probabilities may also be accumulated for individual attributes. For example, an attribute indicating an income of an $0.00 may be assigned an associated probability of p(L1|income=0)=0.99 that may indicate there is a 99% probability that an individual with no income belongs to life stage 1. Or an attribute indicating an income of an $2000.00 may be assigned an associated probability of p(L21|income=2000)=0.98 that may indicate there is a 98% probability that an individual with an income of $2,000 belongs to life stage 2. Life stage probabilities may also be accumulated for neighborhood demographics of an individual, transaction history, medical conditions and other individual attributes. For instance, a medical attribute indicating a condition such as Alzeimer's Disease may be assigned an associated probability of p(L4|Alzeimer's Disease)=0.89 that may indicate there is a 89% probability that an individual with Alzeimer's Disease belongs to life stage 4. Together, the probabilities for the collection of attributes and events for an individual may be considered to determine the life stage of an individual.

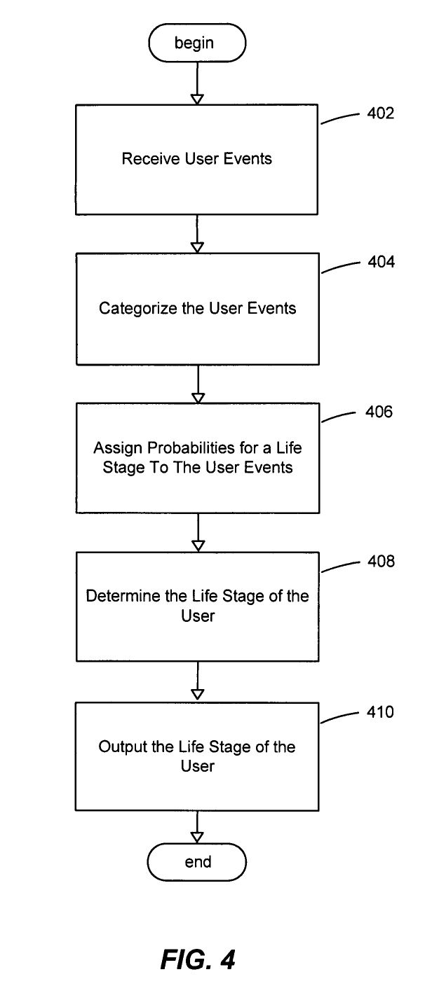

FIG. 4 presents a flowchart generally representing the steps undertaken in one embodiment for generating a life stage profile. At step 402, one or more user events may be received. The events may be online events and/or offline events. At step 404, the user events may be categorized. In an embodiment, the user events may be categorized at step 404 and assigned a probability at step 406 that the user may belong to a particular life stage given the event. In various embodiments, a user event may be classified for several life stages with corresponding probabilities assigned for each respective life stage. At step 408, the life stage of the user may be determined. The life stage profiling engine may apply naïve Bayesian techniques using the assigned probabilities of the events in an embodiment to determine a life stage of an individual. In various embodiments, one or more life stages may be assigned to a user in a user profile. Moreover, there may be one or more life stages assigned for different taxonomies applicable for the user. At step 410, the life stage of a user may be output. In an embodiment, the life stage of a user may be output by storing the life stage in a life stage profile for the user. Those skilled in the art will appreciate that the system may periodically update the life stage profile of an individual for new user events that may be received. In an embodiment, a transition between two life stages may be detected for an individual and advertisements for that life stage change may be sent to the individual. Any life stage change may provide a marketing opportunity for advertisers because usually large transactions may occur during life stage changes. When the system may detect a change in life stage of an individual, the individual may be flagged to receive advertisements for that particular life stage change.

Thus the present invention may be used by applications that may display advertisements to users who visit a website, including managed content properties, to select advertisements using life stage profiles for display with content of the website. Advantageously, an advertisement may be selected using a life stage profile for predictive targeting of online advertisements in addition to using the user profile of the particular user visiting the website. The present invention may more accurately perform predictive targeting in advertisement applications by expanding the tracking history of behavior patterns, transactional events, and descriptive characteristics of an individual to include lifetime events of an individual and family history of the individual including, for example, ancestors, posterity, and medical history. The additional profiling of family lineage may be useful in determining wealth, language, ethnic background, health risks of an individual. In addition to using life stage profiling as part of an application or system for selecting advertisements, those skilled in the art will appreciate that any number of other predictive targeting applications may use life stage profiling such as a content match application.

As can be seen from the foregoing detailed description, the present invention provides an improved system and method for predictive targeting in online advertising using life stage profiling. The system and method may determine user life stage profiles from user events. And predictive behavioral targeting may be applied using one or more life stage profiles to select an individual user or a group of users for any number of applications. For an online search application, an advertisement may be sent to the targeted user or group of users for display. For an online content match application, content may be sent to the targeted user or group of users for display. For an ecommerce application, an offer to complete an ecommerce transaction, such as a purchase, may be sent to the targeted user or group of users. The present invention may more accurately perform predictive targeting for any number of applications. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for user profiling, comprising:
a life stage profiling engine for generating a life stage profile from events;
an event classifier operably coupled to the life stage profiling engine for categorizing online and offline events for generating a life stage profile; and
a storage operably coupled to the life stage profiling engine for storing the life stage of a taxonomy of life stages.

2. The system of claim 1 wherein the storage further comprises a user profile including events used for generating the life stage profile.

3. The system of claim 1 further comprising a predictive targeting application operably coupled to the storage for using the life stage profile to target a user for receiving an advertisement.

4. A computer-readable medium having computer-executable components comprising the system of claim 1.

5. A computer-implemented method for user profiling, comprising:
receiving at least one user event;
categorizing the at least one user event;
assigning a probability for a life stage to the at least one user event;
determining the life stage of a user using the probability for the life stage; and
outputting the life stage of the user.

6. The method of claim 5 further comprising:
receiving at least one user attribute;
categorizing the at least one user attribute;
assigning a second probability for the life stage to the at least one user attribute; and
determining the life stage of the user using the second probability for the life stage.

7. The method of claim 5 further comprising applying predictive targeting using the life stage profile to determine the user for receiving an advertisement.

8. The method of claim 5 further comprising applying predictive targeting using the life stage profile to determine the user for receiving online content.

9. The method of claim 5 further comprising applying predictive targeting using the life stage profile to determine the user for receiving an electronic communication.

10. The method of claim 5 further comprising applying predictive targeting using the life stage profile to determine the user for receiving a non-electronic communication.

11. The method of claim 5 wherein receiving the at least one user event comprises receiving at least one user event from a transactional history of the user.

12. The method of claim 6 wherein receiving the at least one user attribute comprises receiving at least one user attribute from a user profile of the user.

13. The method of claim 6 wherein receiving the at least one user attribute comprises receiving at least one user attribute from a family history of the user.

14. The method of claim 6 wherein receiving the at least one user attribute comprises receiving at least one user attribute from neighborhood demographics of the user.

15. The method of claim 6 wherein receiving the at least one user attribute comprises receiving at least one user attribute from a social network of the user.

16. The method of claim 6 wherein receiving the at least one user attribute comprises receiving at least one user attribute from a medical history of the user.

17. A computer-readable medium having computer-executable instructions for performing the method of claim 5.

18. A computer system for predictive targeting, comprising:
means for generating a life stage profile for a user;
means for applying predictive targeting using the life stage profile to determine the user for receiving an electronic communication; and
means for sending the electronic communication to the user.

19. The computer system of claim 18 further comprising means for applying predictive targeting using the life stage profile to determine the user for receiving a non-electronic communication.

20. The computer system of claim 18 wherein means for generating a life stage profile for a user comprises means for determining a life stage of the user.
